(19) United States
(12) Patent Application Publication
(10) Pub. No.: US 2003/0084188 A1
(43) Pub. Date: May 1, 2003

(54) Multiple mode input and output

(76) Inventors: Hans Daniel Dreyer, Gahanna, OH (US); Timothy Herdklotz, Atlanta, GA (US)

Correspondence Address: LALOS & KEEGAN, Fifth Floor, 1146 Nineteenth Street, N.W., Washington, DC, 20036, US

(21) Appl. No.: 09/984,636

(22) Filed: Oct. 30, 2001

(51) Int. Cl. G06F 15/16

(52) U.S. Cl. 709/246

(57) ABSTRACT

A technique for information exchange is provided. A method and a system utilizing the technique are provided. According to the technique, a message having an input mode is received. A output mode for a response to the received message is determined. A response having the determined output mode is generated. The generated response is then transmitted. The determination of the output mode is independent of the input of the input mode.

### FIELD OF THE INVENTION

The present invention relates to electronic information exchange and more particularly to multiple modes of information input and presentation during an information exchange session.

### BACKGROUND OF THE INVENTION

On-line applications delivered to a user interface over a network have traditionally been of two types: client-server applications and telephony-based applications.

Client-server applications are of two sub-types: fat client applications and thin client applications. In fat client applications at least a portion of the application functionality is located on a user's personal computer (PC). The PC is communicatively connected with the server via a dial-up connection, a proprietary network, or a public network, such as the Internet. The server and the client work in concert in providing the application functionality. In thin client applications, which have recently become more popular than fat client applications, little, if any, of the application functionality is located on a user's PC. In fact, most thin client applications utilize off-the-shelf web browsers to function as the client. The functionality is provided by the server, with the client only handling user presentation and user input.

In both fat and thin client-server applications, a user's input is by way of traditional manual PC input: keyboard and mouse, or other manual means such as digitizing pad or light pen. Presentation of information to the user from the server (output) is usually visual, via a display. Some client-server applications also utilize canned video or audio for presentation.

In telephony-based applications, a user communicates via telephone with a server, known as a voice response unit (VRU) specifically designed to support touch-tone or voice input and to provide voice synthesis for output. The server provides all of the application functionality in telephony-based applications.

The first VRUs were highly menu-based and provided voice recognition for only a fixed, small vocabulary. Recent advances in the state of speech recognition have allowed VRUs to recognize a much richer, often dynamic, vocabulary. This has allowed migration from rigid, hierarchical menus of functions to “natural language” processing, in which the user simply formulates a spoken query or command as he or she wishes, and the VRU system interprets what is to be performed.

Client-server applications have the advantage that user input is precisely and consistently interpreted by the server. Client-server applications are state based. A server presents information to a user from which the user selects commands or queries. The user inputs the command/query in a form dictated by the server. The server expects each command or query input by a user, as well as expects the form of the command or query.

Another advantage of client-server applications is that visual display of information, via a monitor, lends itself to a rich presentation experience. For example, long lists, voluminous text, and graphics can be visually presented.

At the same time, the cumbersome nature of input and output devices associated with personal computers limits portability. Furthermore, client-server applications do not support the most natural manner in which humans convey information, by simply talking. The lack of voice support and the heavy reliance on visual presentation limits such applications' ability to be used by certain classes of the disabled. Solutions directed to providing application functionality to these classes of the disabled have often been awkward and/or costly.

Telephony-based applications have the advantage that they are highly portable, anyone with access to a telephone can avail themselves of offered functionality. Furthermore, many support voice input, the most natural way in which humans communicate. Another advantage of telephony-based applications is that they are especially well suited for brief commands/queries and responses.

At the same time, the telephony-based applications do have inherent disadvantages. Menu based input is often slow and tedious. Also, it is often difficult for a user to remember options presented aurally. If an incorrect user input is made, sometimes returning to the menu from which the incorrect input was made can be difficult, as the user must re-navigate all or many of the menus preceding the menu in which the incorrect input is made.

A disadvantage of voice recognition systems is the need for constant aural feedback from the server for verification of voice recognition, if not actual correction of interpretation errors. This prolongs user sessions. Furthermore, voice synthesis is not well suited for content-rich presentations.

Recently, web-enabled digital wireless telephones have been developed which blur the line of distinction between PCs and telephones. These telephones are capable of operating in two modes. In one, they operate as any wireless telephone. In another, they operate as a limited gateway to the Internet. Input is via the telephone keypad and other keys, and output is via a very small display, typically about 7 lines in depth. These devices do not accept web input via voice, and do not present web information aurally. Additionally, the information available via the Internet on digital telephones is not the same information delivered to a PC via the Internet, it is specially configured for display via web-enabled phone.

Also recently, voice portals have been developed which leverage advanced natural language speech recognition software. Voice portals are designed to provide access to a wide variety of services and information, such as weather, traffic, or stock reports. A user telephones such a voice portal and requests information by voice commands. The requested information is delivered aurally via the telephone. While natural language voice portals do alleviate the problems associated with menu driven user input, the information presented to a user is limited to information which can be presented aurally.

Accordingly, a need exists for a technique of on-line application delivery which combines the advantages of client-server applications and telephony-based applications. Such a technique should support voice input, traditionally associated with telephony-based applications, as well as manual input, traditionally associated with client-server applications. Further, such a technique should also support aural presentation, traditionally associated with telephony-based applications, as well as visual presentation, traditionally associated with client-server applications. And still further, such a technique should differentiate between types of information to be presented and thus present some information visually, some aurally, and some both visually and aurally. This differentiation should be based upon attributes of the information to be presented, which can include preferences as to the form of presentation.

On-line application delivery systems deliver many different types of functionality. One of these types is on-line delivery of electronic commerce services. Electronic commerce applications include applications designed to support retail purchases, applications designed to support business to business transactions, applications designed to support person to person transactions, and applications designed to support home banking, as well as other types of electronic commerce. The following discussion describes home banking applications, though it will be appreciated that the discussion is equally applicable to other types of electronic commerce applications delivered on-line, as well as functionality other than electronic commerce.

In home banking, there are both client-server applications and telephony-based applications. In telephony-based applications, a customer telephones a computer associated with a financial institution to direct transactions and obtain information. Today, a telephone-banking system typically offers one or more service options to the customer via prerecorded messages or voice synthesis capabilities. The customer communicates with the system's computer by using a telephone's touch-tone keypad, or by voice, whereby the computer is programmed to recognize a limited set of verbal commands and words. These telephone-banking systems are typically based upon a hierarchy of menus through which a customer navigates using either the keypad or voice commands. Basic telephone banking systems provide account balances and histories and allow transfer of funds between accounts. More sophisticated telephone banking systems allow customers to direct that payments be made on their behalf.

Client-server home banking applications include proprietary systems whereby a customer communicates with, via a personal computer, a computer associated with the financial institution to direct transactions and obtain information. A customer's computer and a financial institution's computer communicate via modem utilizing a public switched telephone network to establish direct connections to exchange information.

Other client-server home banking applications are based upon the Internet. By simply linking to a bank server, via the Internet, a bank customer accesses account information and communicate transfer instructions.

Home banking has advanced from basic consumer-to-bank communication, either via telephone or computing device, to a consumer being able to electronically make payments and obtain information by communicating, either via telephone or computing device, with a service provider distinct from the financial institute maintaining the account. For payments, a service provider either relays a payment order to the customer's financial institution, or executes payment on behalf of the customer. When a service provider executes payments, funds from a payer's deposit or credit account, i.e. the payer's payment account, are debited by the service provider to cover the payment. For account information, a service provider either requests account information from the customer's financial institution, or maintains account information on behalf of the customer.

Today, in addition to obtaining information and making payments, many home banking systems, whether associated with a financial institution or a service provider, also allow customers to receive billing information. Billing information can include only summary billing information, such as an amount owed and to whom the amount is owed, can include bill detail traditionally found in bills presented via paper (paper bills), and can include supplemental information other than summary or detailed billing information, such as advertisements. It should also be noted that some billers operate their own electronic billing systems.

These exemplary on-line application delivery systems are each bound by the constraints, discussed above, inherent to either client-server systems or telephony-based systems. A technique for on-line application delivery, as discussed above, that includes multiple modes of input and multiple modes of output would allow both input and output to occur in the most natural and effective forms for any given type of information exchanged.

### OBJECTS OF THE INVENTION

It is an object of the present invention to provide a technique for on-line application delivery in which information is presented in at least one of multiple possible presentment forms.

It is a further object of the present invention to provide a technique for on-line application delivery in which information is presented in at least one of multiple possible presentment forms dependent upon at least one attribute of that information.

It is yet another object of the present invention to provide a technique for on-line application delivery which accepts user input in one of multiple forms.

It is still another object of the present invention to provide a technique for on-line application delivery in which an information input form does not dictate an information output form, and in which an information output form does not dictate an information input form.

The above-stated objects, as well as other objects, features, and advantages, of the present invention will become readily apparent from the following detailed description which is to be read in conjunction with the appended drawings.

### SUMMARY OF THE INVENTION

In accordance with the invention, a method for information exchange and a system for implementing the method are provided. The information may be any type of information which is exchanged.

The system includes a first network station and a second network station. A network station can be any type of device capable of transmitting information via a network, including, but not limited to, a conventional telephone, a personal computer, a mainframe computer, a server computer, a set-top box, a personal digital assistant, or a wireless telephone, among possible types of devices. A network could be any type of network capable of carrying transmitted information, including, but not limited to, a public switched telephone network, a private data network, such as an intranet, or a public data network, such as the Internet, among possible types of networks.

In accordance with the method, a message having an input mode is received. An input mode is how information is input at a network station. Input modes include, but are not limited to, input by microphone, input by keypad, input by keyboard, input by mouse, input by digitizing pad, input by touch screen, and input by light pen, among possible modes of input.

Upon receipt of the message, a determination of an output mode for a response to the received message is made. An output mode is how information is presented at a network station. Output modes include, but are not limited to, output by monitor, output by display screen, and output by speaker or speakers, among possible modes of output.

A response to the received message is generated to have the determined output mode. Generating a response to have an output mode causes the response to be presented by the determined output mode. The generated response is transmitted.

The determination of the output mode is independent of the input mode. That is, the input mode in no way controls or determines the output mode. The input mode does not affect the determination of the output mode. Thus, a response to a message input by microphone could be determined to be output by display or monitor. Likewise, a response to a message input by keyboard or keypad could be output by speaker.

According to another aspect of the invention, the message is received via a first network session, and the response is transmitted via a second network session different than the first network session. A network session is any open connection between two communicating entities over which information or instructions are exchanged. The first and the second network sessions could be sessions via a same network, or could be network sessions via different networks. The first and second network sessions could be two distinct network sessions between two communicating entities, such as the first network station and the second network station. If two distinct sessions between two entities, the two distinct sessions could be simultaneous sessions, or could be non-simultaneous sessions. Also, the first network session could be a network session between one entity and another entity, and the second network session could be a network session between the one entity and yet another entity, either via different networks or via the same network.

According to yet another aspect of the invention, the message is received via a network session, and the response is transmitted via the same network session. Thus, according to this aspect, the message and the response are transmitted/received during the same network session.

According to an advantageous aspect of the invention, the message is received from a customer of a financial services provider by the financial services provider. The received message is a request for the financial services provider to provide a financial service for the customer. The provided financial service could be any type of financial service, including, but not limited to, bill payment, bill presentment, funds transfer, account maintenance, or investment services, among possible types of financial services.

In a particularly beneficial aspect of the invention, the determination of the output mode is based upon at least one of the following factors: content of the response, volume of the response, preferences associated with an entity from whom the message is received, preferences associated with an entity receiving the message, preferences associated with a sponsor of the entity from whom the message is received, and a type of device from which the message is received. A sponsor is an entity which grants the entity from whom the message is received access to the entity receiving the message.

Thus, the output mode could be dependent, at least in part, upon the particular information to be conveyed by the response, with some types of content having one output mode, and with other types of content having another output mode.

The output mode could be dependent, at least in part, upon the amount of information to be presented, with larger volumes of information having one output mode, and with smaller volumes of information having another output mode.

If the determination of the output mode is made, at least in part, based upon preferences, whether of an entity from whom the message is received, of an entity receiving the message, or of a sponsor, the preferences can be general preferences applicable to all responses, or specialized preferences applicable to only certain responses. Further, preferences can be preferences for only one instance of a response.

The determination of the output mode could be dependent, at least in part, upon the presentation capabilities of a device from which the message is received, such as the first network device.

According to another aspect of the invention, the output mode is a first output mode. The response is generated to have a second output mode different than the first output mode. This second output mode is dependent upon the input mode. The response generated to have the second output mode is transmitted. The response having the second output mode conveys at least a portion of the information conveyed by the response having the first input mode. Thus, two responses are generated, one having a first output mode, and another having a second output mode. The response is presented in two ways.

In a particularly advantageous aspect of the invention, the input mode is either a vocal input mode or a manual input mode. In the vocal input mode, the message is preferably input by voice utilizing a microphone. In the manual input mode, the message is preferably input by hand. In the manual input mode, the message is input by a manual input device, including, for example, a keyboard, a keypad, a mouse, a touch screen, a digitizing pad, or a light pen, among possible manual input devices. Further, a combination of manual input devices can be utilized in the manual input mode.

The output mode is either an aural output mode or a visual output mode. In the aural output mode, the response is presented by speaker. In the visual output mode, the response is presented by monitor or display screen.

In a further advantageous aspect of the invention, the transmitted response is received, the output mode of the response is determined, and the response is presented. If the output mode is determined to be the visual output mode, the response is presented visually. If the output mode is determined to be the aural output mode, the response is presented aurally.

In another aspect of the invention, the input mode of the received message is determined. Determining the input mode can include, but is not limited to, recognizing control codes contained in the received message.

It will also be understood by those skilled in the art, that the invention is easily implemented using computer software. More particularly, software can be easily programmed, using routine programming skill, based upon the description of the invention set forth herein and stored on a storage medium which is readable by a computer processor of the applicable component, e.g. first network station, second network station, or third network station, to cause the processor to operate such that the particular component performs in the manner described above.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is a simplified depiction of a multi-modal home banking system, including a customer device and a central station, and individual components thereof, in accordance with a first embodiment of the invention.

FIG. 2 is a simplified flow chart depicting the operations performed by the central station to transmit information for multi-modal presentation in accordance with the first embodiment of the invention.

FIG. 3 is a simplified flow chart depicting the operations in processing received information at the customer device in accordance with the first embodiment of the invention.

FIG. 4 is a simplified flow chart depicting the operations in processing received information at the central station in accordance with the first embodiment of the invention.

FIG. 5A and 5B are simplified flow charts depicting the operations in providing multi-modal services in accordance with the first embodiment of the invention.

FIG. 6 is an exemplary depiction of a welcome page presented to a user in accordance with the first embodiment of the invention.

FIG. 7A is an exemplary depiction of an options page presented to a user when a selected option will be manually input in accordance with the first embodiment of the invention.

FIG. 7B is an exemplary depiction of an options page presented to a user when a selected option will be input by voice in accordance with the first embodiment of the invention.

FIG. 8 is a simplified flow chart depicting the operations to access the central station in accordance with a second embodiment of the invention.

FIG. 9 is a simplified depiction of a home banking system, including a customer device, a telephone, and a central station, and components thereof, in accordance with the second embodiment of the invention.

FIG. 10 is a simplified flow chart depicting the operations in providing multi-modal services in accordance with the second embodiment of the invention.

### DETAILED DESCRIPTION OF PREFERRED EMBODIMENTS

### First Embodiment

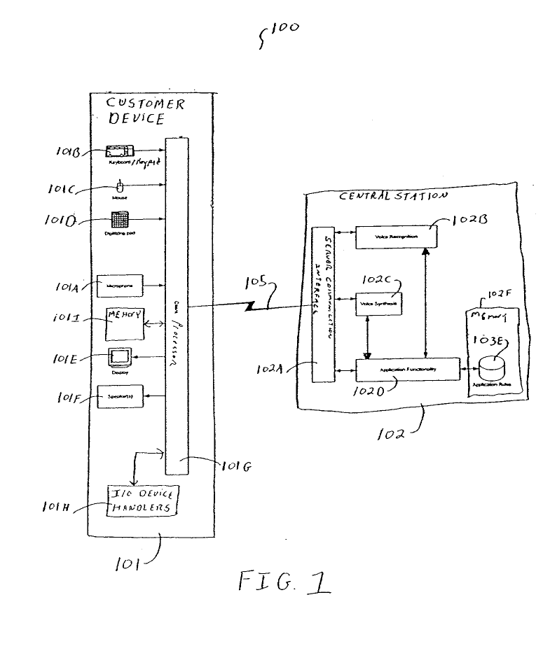

Referring to FIG. 1, a home banking system 100 in accordance with a first embodiment of the present invention is shown. It should be understood that the system 100 could be any system for on-line delivery of application functionality. A home banking system is merely used as an example of one type of application functionally that can be delivered on-line in accordance with the present invention. The system includes at least one customer device 101 and a central station 102. It will be understood that such a system will have thousands, if not millions of such customer devices 101, though for simplicity, only one customer device 101 is depicted in FIG. 1. The customer device 101 preferably includes at least the input means of a microphone 101A and a keyboard or keypad 101B. The customer device 101 can also include one or more other input means, such as a mouse 101C, digitizing pad 101D, or other means. The customer device 101 also preferably includes at least the output means of a display 101E and a speaker 101F. The various input and output means are communicatively interconnected with a client processor 101G and are each controlled by one of multiple I/O device handlers 101H, which are each also in communication with the client processor 101G. Additionally, the customer device 101 also includes a memory 101I in communication with at least the client processor 101G.

The central station 102, which can be associated with a financial institution or a service provider, includes a server communication interface 102A in communication with a voice recognition subsystem 102B, a voice synthesis subsystem 102C, and an application functionality subsystem 102D. The voice recognition subsystem 102B and the application functionality subsystem 102D are shown communicatively interconnected. Also, the voice synthesis subsystem 102C and the application functionality subsystem 102D are shown communicatively interconnected. The central station 102 also includes an application rules database 102E stored in a memory 102F communicatively interconnected with the application functionality subsystem 102D. The memory could also be communicatively interconnected with one or more other subsystems.

Though the voice synthesis subsystem 102C and the voice recognition subsystem 102B are, in this embodiment, associated with central station 102, one skilled in the art will recognize that one or both could be associated with the customer device 101.

The customer device 101 and the central station 102 communicate via a network 105. The network is preferably the Internet, though any type of communications network capable of transmitting data could be utilized.

The client processor 101G, in combination with the I/O device handlers 101H and in addition to other functions, detects input from any of the input devices and processes the detected input. When the client processor 101G detects input (voice) from the microphone 101A the client processor processes and transmits the input to the central station 102. The processing of voice input by the client processor 101G will be discussed below. It should be understood that that input via the microphone 101A does not control or direct operations of the user device 101. Input from manual input means, such as keyboard/keypad 101B, mouse 101C, or digitizing pad, is detected and processed for transmission by the client processor 101G, according to any well-known technique for processing input from these sources. The client processor 101G transmits the processed information to the central station 101.

The client processor 101G also receives information from the server communication interface 102A, determines the type, i.e., voice or data, of the information received and processes the information accordingly. Client processor 101G processing of received information will be discussed further below. Dependent upon the type of information received, and in conjunction with the I/O device handlers 101H, the client processor routes the processed information to an appropriate output device, i.e., the display 101E or the speaker(s) 101F.

Server communication interface 102A, in addition to other functions, detects information received from the client processor 101G and determines the type of information received, i.e., voice or data. After determination of the data type, the server communication interface 102A processes the received information accordingly and routes the information to the appropriate subsystem, i.e., the voice recognition subsystem 102B or the application functionality subsystem 102D.

The server communication interface 102A also routes information processed by the voice recognition subsystem 102B to the application functionality subsystem 102D. Alternatively, and as shown in FIG. 1, the voice recognition subsystem 102B is also communicatively interconnected with the application functionality subsystem 102D. Thus, information processed by the voice recognition subsystem 102B can be passed directly to the application functionality subsystem 102D, bypassing the server communication interface 102A.

The server communication interface 102A also routes information from the application functionality subsystem 102D to the voice synthesis subsystem 102C. Alternatively, and as shown in FIG. 1, the voice synthesis subsystem 102C and the application functionality subsystem 102D are communicatively interconnected. Thus, information can also be directly passed from the application functionality subsystem 102D to the voice synthesis subsystem 102C, bypassing the server communication interface 102A.

The server communication interface 102A also receives information from the application functionality subsystem 102D and the voice synthesis subsystem 102C, detects the source and/or type of information, processes the information accordingly, and transmits the information to the client processor 101G via network 105.

The application rules database 102E stores rules that define the preferred input and output form for various classes and sub-classes of information exchange between the customer device 101 and the central station 102. That is the rules dictate whether information will be presented, at the customer device 101, aurally via the speaker(s) 101F or visually, via the display 101E, and whether information will be input at the customer device 101 vocally, via the microphone 101A, or manually via another input means.

The rules stored in the application rules database 102E include default rules and user-specific preference rules. At least some of the default rules are configurable by a user associated with a customer device. The central station 102 utilizes default rules until a user overrides the defaults by establishing user-specific preference rules. A user can establish preference rules either on-line or via a customer care request. In a customer care request, an operator associated with the central station 102 effects the default override.

The rules stored in the application rules database 102E also include sponsor-specific rules. Sponsor-specific rules apply to all users who are associated with a particular sponsor. A sponsor provides access to the functionality provided by the central station 102 on behalf of each of a group of users, such as customers of a business. A user, provided access by a sponsor, may override sponsor-specific rules and set user-specific preference rules if that user's sponsor allows the setting of user-specific preference rules.

The rules stored in the application notes database 102E also include customer device-specific rules. That is, dependent upon the type of customer device, certain information will be presented differently. For example, if the customer device is a web-enabled phone, information configured for visual display will be configured differently than information configured for visual presentation via a monitor associated with a PC, due to the differences in display area between the devices.

The application functionality subsystem 102D directs interaction with the customer device 101. As will be discussed below, the application functionality subsystem 102D causes various information to be transmitted to the customer device 101 in providing electronic commerce services to a customer. The transmitted information will either be presented to the user via the display 101E or via the speaker(s) 101F. The application functionality subsystem 102D also processes information received from the customer device 101 in providing electronic commerce services to a user. The received information will be input by the user at the customer device 101 either by voice via the microphone 101A, or manually by one of the other input means.

As will be understood by one skilled in the art, the Voice Over Internet Protocol (VoIP) enables voice to be transmitted over the Internet, or other networks, much like voice is transmitted over the public switched telephone network. In VoIP, an analog voice signal is digitized and compressed into voice packets at a first location. The voice packets include header information that identifies the packets as VoIP packets, as well as provides information for the reassembly of the packets. These voice packets are then transmitted to a second location where they are reassembled and converted back into an analog voice signal. Both the client processor 101G and the server communication interface 102A are configured to receive voice input, digitize that input according to the VoIP, transmit the digitized input to the other, and convert digitized input back to voice. The sever communication interface is further configured to route converted voice to the voice recognition sub-system 102B for processing.

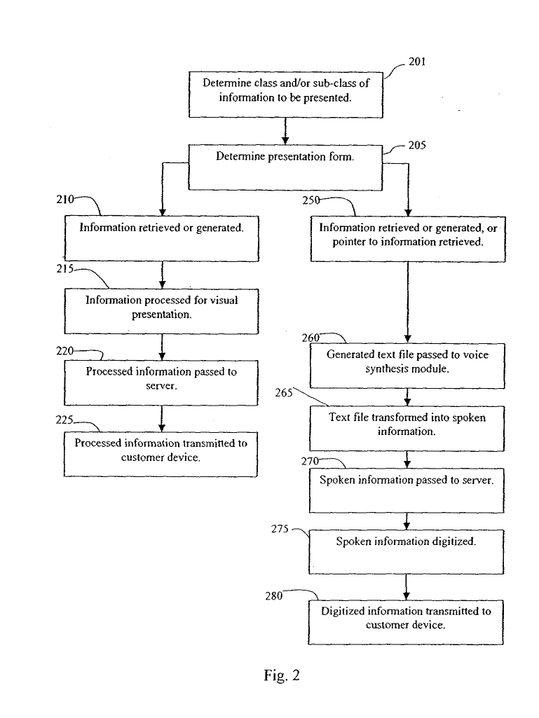

FIG. 2 is a flow chart depicting exemplary processing to transmit information for presentation in one of two forms, i.e. visually or aurally, to the customer device 101 from the central station 102. This information could be any information transmitted from the central station 102 to the customer device 101. At step 201, the application functionality subsystem 102D determines the class and/or sub-class of information to be transmitted. For example, the determined class/sub-class could be bill detail. Though not depicted in FIG. 2, the identity of a user associated with the customer device 101 is known to the application functionality subsystem 102D at this point, as well as the type of customer device. The application functionality subsystem 102D accesses the application rules database 102E, and determines the presentation form of the determined information class and/or sub-class, step 205. This could be a default form, a sponsor-specific form, a user-specific form, or a device—specific form, dependent upon the user's identity, the type of information, and the type of customer device. If the determined presentation form is visual, operations continue with step 210. If the determined presentation form is aural, operations continue with step 250.

After determining that presentation will be visual, the application functionality subsystem 102D prepares the information for visual presentation. Preparing the information for visual presentation includes retrieving the information from memory 102F, or generating the information as necessary, step 210. After retrieval or generation, the application functionality subsystem 102D preferably formats information according to the hypertext mark-up language (HTML), step 215. One skilled in the art will understand the processing necessary to format the information in HTML. However, preparing the information for visual presentation could also include processing the information in a way other than formatting the information in HTML. Any formatting or processing of information which results in a visual presentation of the information could be utilized in accordance with the present invention.

At step 220 the processed information is passed to the server communication interface 102A. The server communication interface detects the type of information, voice or visual, prepares the information for transmission, and transmits the prepared information to the customer device 101, step 225. Receipt of transmitted information at the customer device 101 is discussed further below.

After determining that the presentation will be aural, the application functionality subsystem 102D prepares the information for aural presentation. This includes either retrieving the information to be voice synthesized from memory 102F, generating the information as necessary, or retrieving an index pointer to a voice synthesis repository, step 250. It should be noted that the step of retrieving or generating the information, for both aural and visual presentation, could be performed prior to determining the form of presentment.

At step 260 the generated text file is passed to the voice synthesis subsystem 102C. Discussed above, this can be a direct pass from the application functionality subsystem 102D to the voice synthesis subsystem 102C, or the text file can be passed to the server communication interface 102A from the application functionality subsystem 102D. The server communication interface 102A then passes the text file to the voice synthesis subsystem 102C. Information routed by the server communication interface 102A includes routing directions which are interpreted by the server communication interface 102A.

The voice synthesis subsystem 102C processes the text file to transform the text file into spoken word, step 265. One skilled in the art will understand the processing necessary for voice synthesis.

At step 270, the voice-synthesized information is passed from the voice synthesis subsystem 102C to the server communication interface 102A. The server communication interface performs the conversion of the spoken information for transmission via network 105, discussed above, step 275. The server communication interface then transmits digitized information to the customer device, step 280.

As will be discussed below, some of the classes/sub-class of information transmitted from the central station 102 to the customer device 101 is presented both visually and aurally.

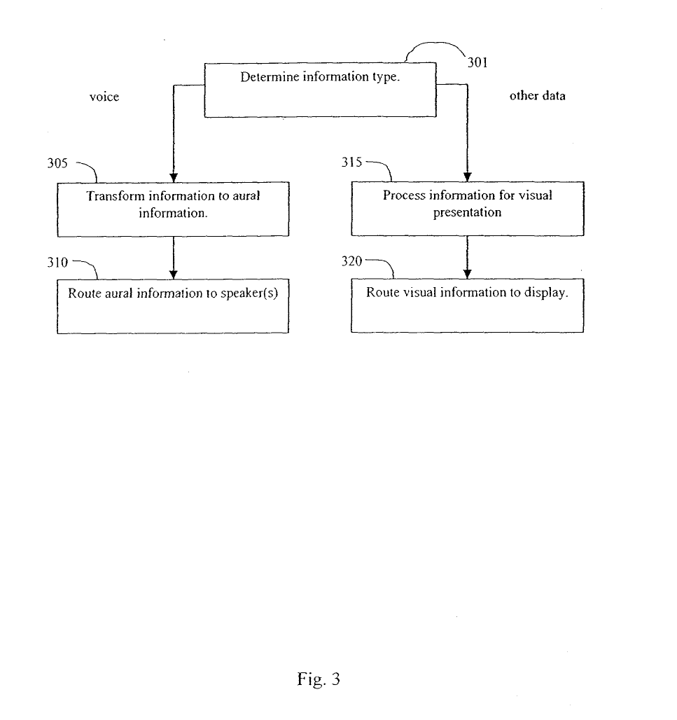

FIG. 3 depicts processing performed by the client processor 101G upon receipt of information via the network 105. At step 301 the client processor 101G determines whether voice or data information is received. This determination is made based upon control information contained in the transmitted information, as will be understood by one skilled in the art. For example, VoIP (voice) information will be identified by information contained in a VoIP header. And, formatting control information indicating HTML code will identify HTML (DATA) information.

If the information is identified as VoIP information, the client processor 101G will reassemble the VoIP packets and transform the reassembled packets into analog voice information, step 305. Then, at step 310, and in conjunction with the I/O device handlers 101H, the transformed voice information is routed to the speaker(s) 101F for presentment.

If the information is identified as HTML formatted information for visual presentation, or other visual information, the client processor 101G processes the information for visual presentation in accordance with the formatting, step 315. This processing will be understood by one skilled in the art. The processed information is routed to the display 101E, in conjunction with the I/O device handlers 101H, step 320.

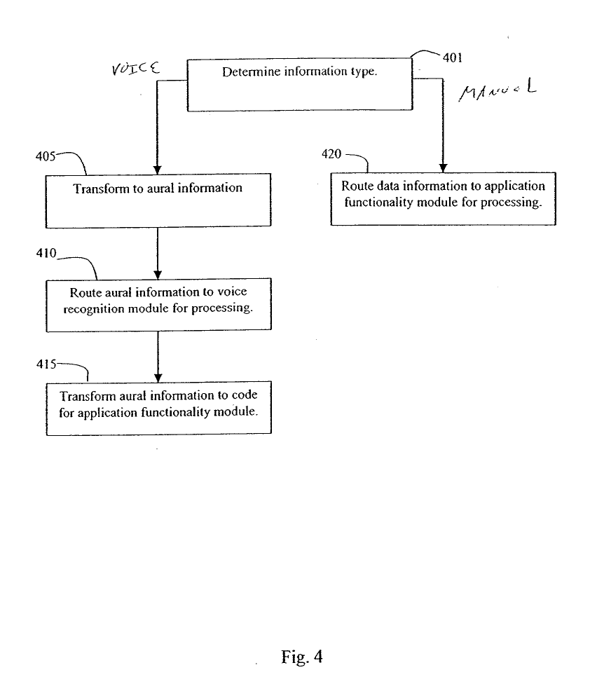

FIG. 4 depicts processing performed by the server communication interface 102A upon receipt of information via the network 105. At step 401 the server communication interface 102A determines whether the received information is voice input or manual input. This determination is made based upon control information contained in the transmitted information, discussed above.

If the information is identified as VoIP (voice) information, the server communication interface 102A will reassemble the VoIP packets and transform the reassembled packets into analog voice information, step 405. Then, at step 410 the transformed voice information is routed to the voice recognition subsystem 102B. The voice recognition subsystem 102B functions to transform a user's spoken voice into code which is recognizable by the application functionality subsystem 102D, step 415.

If the information is identified as having been manually input, the server communication interface passes the information to the application functionality subsystem 102D for processing, step 420. This information could be a query-string via HTTP, a POST command with a date bundle, or structured according to an XML-based protocol.

Transmitted information falls into one of three classes: prompt information, client response/instruction information, and server response information. Prompt information is information transmitted from the central station 102 to the customer device 101 that requests user input. Client response/instruction information is information transmitted from the customer device 101 to the central station 102 that directs the central station 102 to provide information or perform or facilitate a function. Server response information is information transmitted from the central station 102 to the customer device 101 in response to a user request for information or user request for performance or facilitation of a function. Server Response information is information associated with a specific user. Also, transmitted information can be both server response and prompt information, e.g. presentation can contain both user specific information in addition to standard prompt information. Introduced above, the rules in the application rules database 102D define not only the presentation form of information transmitted to the customer device 101 from the central station 102, but also the input method of the information transmitted to the central station 102 from the customer device 101. Thus, the form of the client response/instruction information is dictated by rules stored in the application rules database 102E. The central station 102, in sending each instance of prompt information, also transmits control information which directs the client processor 101G to accept one or both types of input, voice or manual.

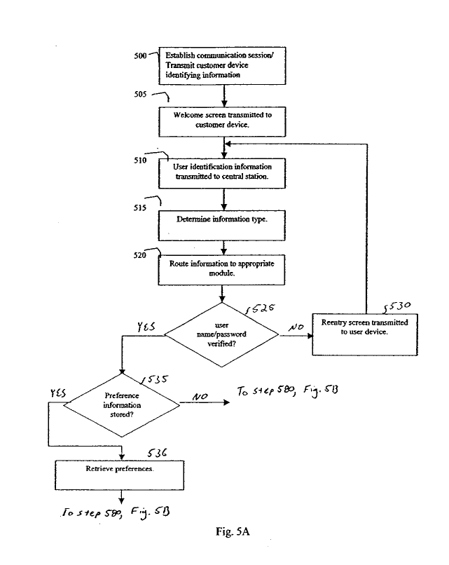

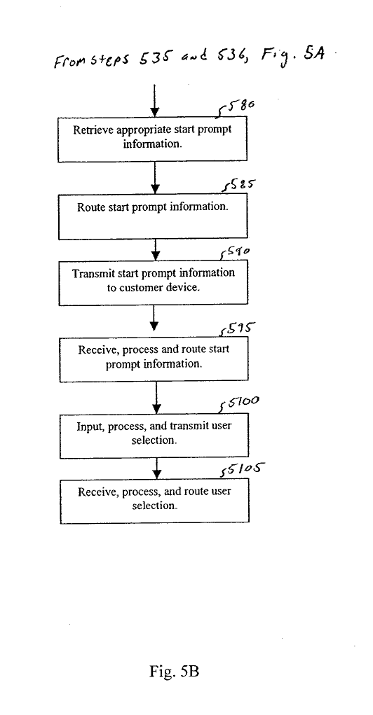

FIGS. 5A and 5B depict exemplary operations in accessing the central station 102 to direct performance or facilitation of electronic banking services via a network in accordance with this first embodiment of the present invention. However, it will be readily apparent that other types of services or interactions can be advantageously performed or facilitated by the present invention. At step 500 a communication session between the customer device 101 and the central station 102 is established. Preferably, the communication session is initiated by a user associated with the customer device 101. The communication session could be established by the user directing the customer device 101 to establish, via modem and a telephone network, a direct communication link with the central station 102. Or, the communication session could be established by the user directing the client processor 101G to establish via the Internet a communication link with a network address associated with the central station 102. Establishing a communication session includes the client processor 101G transmitting information identifying the type of customer device, i.e., web-enabled telephone, P.C., or another type of device.

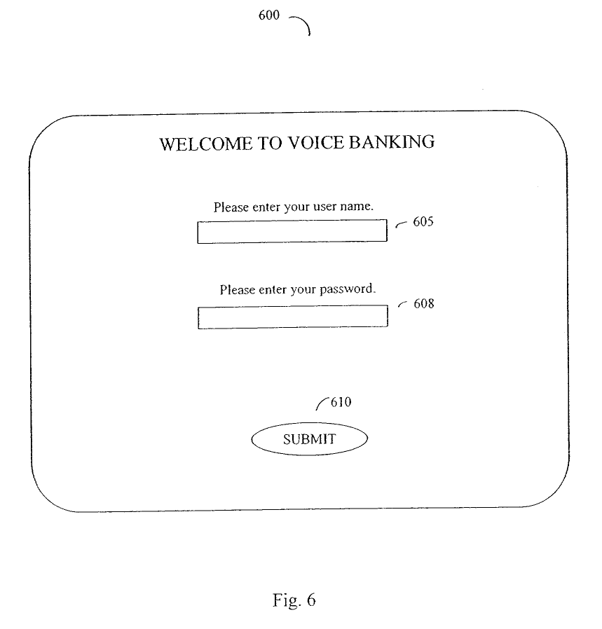

A welcome screen is transmitted by the central station 102 to the customer device 101, step 505. The welcome screen 600, as depicted in FIG. 6, includes an entry point for the customer to enter a user name 605, an entry point for the customer to enter a user password 608, and a submit button 610. The welcome screen, however, can have a different visual appearance than depicted in FIG. 6. After entry of the requested information, an activation of the submit button causes the user name and user password to be transmitted to the central station 102 as one or more text strings, step 510.

At step 515 the server communication interface receives the transmitted text string(s) and determines if the received information is data or voice information. As this is data (textual information), the server communication interface routes the information to the application functionality subsystem 102D, step 520.

The application functionality subsystem 102D accesses authentication information stored in memory 102F to verify the user name and password, step 525. Of course, other types of user authentication could be utilized. For example, biometric data could be utilized, or a sponsor could provide authentication information on behalf of a user.

If the verification fails, the application functionality subsystem 102D retrieves a reentry screen (not shown) from memory 102F and passes it to the server communication interface, which transmits it to the customer device. The user reenters his or her user name and/or password. This process continues one or more times, step 530.

If and when the user's identity is verified, processing continues with step 535. In this step, the application functionality subsystem 102D accesses the application rules database 102E and determines if preferences for prompt, client response/instruction, or server communication interface response information is stored in the database. First, it is determined if any user preferences are stored. If not, it is determined if any sponsor preferences are stored. And finally, if no user or sponsor preferences are stored, default rules are utilized.

If at step 535 it is determined that no preferences are stored, operations continue with step 580. If it is determined that preferences are stored, operations continue with step 536 in which stored preferences are retrieved from the application rules database 103E. Operations then continue with step 580.

Discussed above, client response/instruction information can either be input by a user by voice, utilizing the microphone 101A, or manually by hand, utilizing another input means such as mouse 101C, keyboard/keypad 101B, digitizing pad 101D, some combination thereof, or some other manual input means. The manner in which client response/instruction information will be input, at least in part, dictates the form of a prompt. That is, each client response/instruction is preceded by a prompt. The prompt prepares the customer device 101 for the inputting of client response/instruction information. For manual input of client response/instruction information, the prompt must at least be visual, if not both visual and aural.

Therefore, if a user has requested manual input of client response/instruction information, the prompt preceding that client response/instruction will necessarily include a visual display that will be manipulated by the user to input the client response/instruction and to cause that client response/instruction to be transmitted. Manipulation can include, but is not limited to, selecting a presented option, and entering information is a designated portion of the display. If that user, wishing manual input, wishes to also receive voice prompts, that user will essentially receive two prompts at the same time, one voice, and one visual. However, a user wishing to utilize voice input can receive either, or both, visual and aural prompts.

At step 580 the application functionality subsystem 102D retrieves start prompt information from memory 102F. The information retrieved is dependent upon any stored preferences and any constraints associated with the customer device 101. That is, the memory stores start prompt information, as well as all prompt information, in multiple forms. This multiple storage alleviates the necessity to generate prompt information for each instance of prompt transmission. Any retrieved start prompt information configured for voice presentation is passed from the application functionality subsystem 102 to the voice synthesis subsystem 102C for processing, and any retrieved start prompt information for visual presentation is passed to the server communication interface 102A for transmission, step 585.

Preferably, if both prompt information for visual presentation and prompt information for aural presentation are to be transmitted, the server communication interface is configured to transmit both instances of the prompt information at essentially the same time. Thus, visual prompt information is held until voice synthesized prompt information is received and converted according to the VoIP.

At step 590 the prompt information, whether visual, aural, or both visual and aural, is transmitted to the customer device 101 by the server communication interface 102A. The client processor 101G receives the start prompt information, determines the type of presentation, voice or visual, and appropriately processes and routes the information to one or more output devices, step 595.

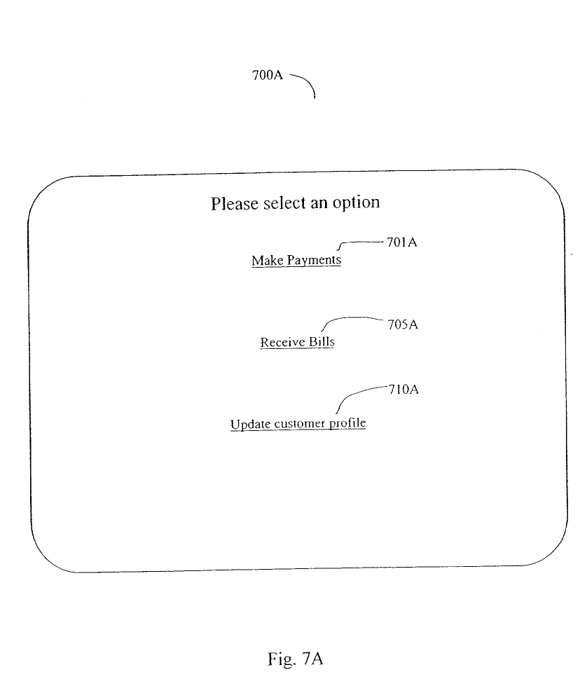

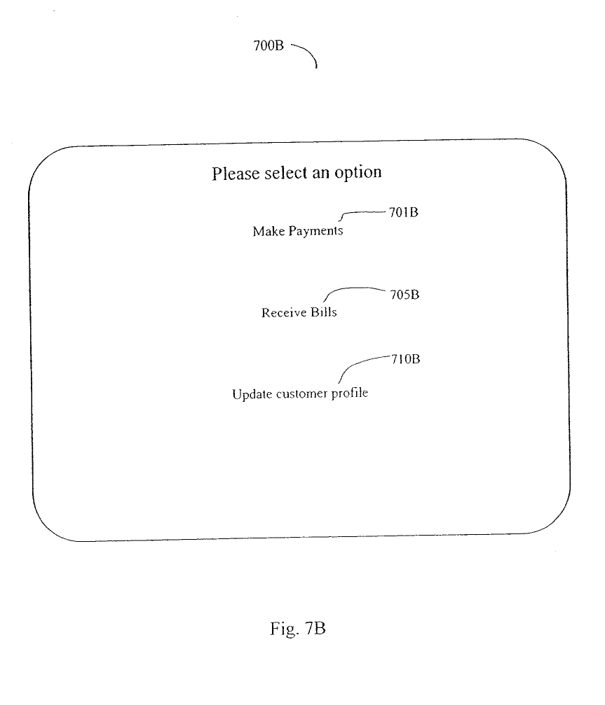

A visual start prompt queues the user to select one of multiple options, as depicted in FIGS. 7A and 7B. FIG. 7A depicts an exemplary start prompt screen 700A presented for manual input. In this example the screen includes one or more links 701A, 705A, and 710A that a user manually activates to cause information to be transmitted to the central station 102. It should be noted that if this were a prompt requiring the user to supply information, a space would be provided for that user to enter information manually. FIG. 7B depicts a visual start prompt screen 700B for those users desiring to input client request/instruction information via voice. While the information conveyed is the same as in FIG. 7A, this screen does not include links, entry points for information, or other user manipulable indicia.

In these examples, a customer can select to make payments 701A, 701B, view billing information 705A, 705B, or update a user profile 710A, 710B. However, it will be appreciated that more or less options could be presented to a user. For those users having requested voice prompts, those users will hear essentially the same information as depicted in FIGS. 7A and 7B. For example, a user could hear “Please select one of the following choices, make payments, view bills, update your user profile.”

At step 5100 a user inputs a selection, the client processor processes the input according to the input method, voice or manual, and transmits it to the central station 102. This selection is client response/instruction information. The server communication interface 102A receives the transmitted selection, identifies the type of information, voice or data, processes it accordingly, and routes it to the appropriate subsystem, step 5105. Discussed above, voice information will be routed to the voice recognition subsystem for conversion into data for processing by the application functionality subsystem 102D, and data will be routed directly to the application functionality subsystem 102D. The application functionality subsystem 102D determines the selection made by the user and generates and/or retrieves from memory 102F appropriate prompt or functionality information for transmission to the customer device 101.

Thereinafter, the user selection is facilitated by a series of interactions between the customer device 101 and the central station 102. As will be understood by the above discussion, information input at the customer device 101 will either be voice input or manual input. Likewise, information output at the customer device 101 will either be visual or aural. Different types of input and output, and their forms, will be discussed below. However, it should be understood that the discussion below is not an exhaustive list of the information which can be transmitted between the customer device 101 and the central station 102, or exhaustive of the on-line application delivery that can be performed by the central station.

In providing the exemplary service of making payments on behalf of a user, at least the name of a payee and a payment amount are specified by the user. The above-described multiple modes of information input can be used for input of this information, dependent upon any preferences and default rules stored in the application rules database. However, and preferably, the payment aspect of the service includes other features. The application functionality subsystem 102D is configurable to facilitate one or more of these other features.

For example, a user can direct the central station 102 to store one or more lists of frequently paid payees. The process of establishing such a list can include the user manually inputting information identifying payees and can include the user providing such information via voice, or some combination thereof. For example, a user may input payee-identifying information by voice utilizing the microphone 101A, and confirmation of that identifying information may be returned for visual presentation via display 101E for manual editing by the user.

If such lists are utilized, preferably whenever a user wishes to make a payment, payee-identifying information is transmitted from the central station 102 to the customer device 101. This information can be configured for either aural or visual presentation, or both, dependent upon defaults or preferences. As a preferable default, the application rules database 102E stores information indicating that such payee lists are to be presented visually. Of course, this default could be that payee lists are to be presented aurally. And, the application functionality subsystem 102D can be configured to determine the number of payees included in a list, and based upon that number, either present the list visually, aurally, or both.

Another payment feature is payment history. A history of the payments facilitated by the central station 102 can be stored in the memory 102F. Upon a user request, that history is transmitted to the customer device 101 for presentation. Such a payment history can be all payments facilitated by the central station 102. Though preferably, a user will define, upon each instance of requesting history presentation, limiting criteria, such as payments to a particular payee, payments made within a certain range of dates, or payments meeting certain amount criteria, or some combination of these and other criteria. The application functionality subsystem 102D will access the memory 102F and retrieve the appropriate payment history information. A payment history request, as well as limiting criteria, can be input manually or by voice, dependent upon defaults or preferences.

Payment history can be presented visually or aurally, or a combination of both. As above, dependent upon the number of entries in a payment history to be presented, or other criteria, the application functionality subsystem 102D can is configurable to determine if presentment will be aurally or visually.

In providing another exemplary service, electronic bill presentment, at least the name of a biller and a bill amount is transmitted for presentment from the central station 102 to the customer device 101. This information can be presented aurally, visually, or both, dependent upon default rules, sponsor rules, or user specific rules stored in the application rules database 102E.

As in a payment service, other features are preferably included in an electronic bill presentment service. One such feature is presentment of bill detail in addition to the summary information of the biller's identity and bill amount. Bill detail includes such information as line item entries included in a bill, such as individual charges, bill due date, account numbers, and the like. Preferably, bill detail is presented visually due to the volume of information. However, a user could change this default to aural presentation.

Another electronic bill presentment feature is presentment of supplemental information. Supplemental information is any information other than summary or detailed information. This includes advertisements typically included with paper bills, information upon which a bill is based, such as a contract, or any type of information other than summary or detailed billing information. This information is preferably presented visually due to multiple factors. First, such information is usually voluminous, secondly, the visual form of the information is often an integral part of the presentation experience.

The present invention also facilitates improved customer care. For example, though not shown in FIG. 1, the central station 102 can optionally include a microphone. A user, while availing himself or herself of the services of the central station 102, whatever those service may be, establishes an interactive voice session with a customer care representative who will guide the user in his or her interaction with the central station 102. Additionally, a customer care representative can advantageously provide other assistance, such as maintenance of a customer profile. A customer care session is established by a user either speaking a command to cause a customer care session to be established, or manually inputting such a command.

The discussion above recites, and FIG. 1 shows, that the customer device 101 is capable of both voice and manual input, and both aural and visual presentation. However, in accordance with this first embodiment, a customer device 101 is not required to have dual input and/or output. Each time a session is established between a customer device and the central station 102, the client processor transmits information indicating if the customer device is capable of voice input and aural output. The central station 102 configures information exchange dependent upon the capabilities of the customer device, much the same way information exchange is configured dependent upon preferences.

### Second Embodiment

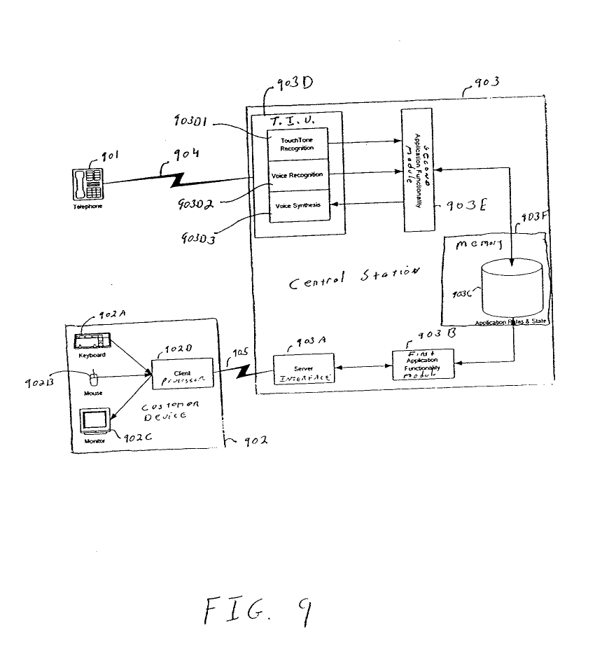

Referring to FIG. 9, a home banking system 900 in accordance with a second embodiment of the present invention is shown. As above it should be understood that the system 100 could be a system for on-line delivery of any type of functionality. The system includes a telephone 901, a customer device 902, and a central station 903. The customer device 902 can be any commercially available personal computer. As shown, the customer device 902 includes the input means of a keyboard 902A and a mouse 902B, though other conventional input means, such as digitizing pads and light pens, are within the scope of this second embodiment. The customer device also includes the output means of a monitor 902C. A client processor 902D is communicatively connected with the input and output means.

The telephone 901 communicates with the central station 903 via the public switched telephone network 904. The customer device 902 communicates with the central station 903 via network 905. Network 905 is preferably the Internet, though any type of communications network capable of transmitting data could be utilized. It should be understood that two user sessions are established with the central station in this second embodiment. FIG. 9 shows two devices, a P.C. and a telephone, each supporting one session. However, it should be understood that a single device could support two sessions.

The central station 903 includes a server communication interface 903A in communication with a first application functionality subsystem 903B. The central station 903 also includes a telephone interface unit (TIU) 903D in communication with a second application functionality subsystem 903E. The TIU 903D includes a touchtone recognition subsystem 903D1, a voice recognition subsystem 903D2,and a voice synthesis subsystem 903D3. The TIU 903D can be any commercially available telephone interface unit. The voice recognition sub-system 903D2 can optionally be excluded from the TIU 903D.

The first functionality subsystem 903B and the second functionality subsystem 903E are each communicatively interconnected with an application rules and state (ARS) database 903C. The ARS database 903C is stored in memory 903F. The server communication interface 903A and first application functionality subsystem 903B can be located physically separate from the TIU 903D and the second application functionality subsystem 903D. Likewise, the ARS database 903C can be located physically separate from any of the other components of the central station 903.

The client processor 902D is preferably configured to function as any conventional web browser in transmitting and receiving data. Likewise, the TIU 903D functions as any conventional telephone interface unit to transmit and receive voice. The operations of a TIU will be understood by one skilled in the art.

The first application functionality subsystem 903B directs interaction with the customer device 902. The second application functionality subsystem 903E directs interaction with the telephone 901. Each of application functionality subsystems 903B and 903E processes received information in providing electronic commerce services to a user. Likewise, each causes information to be transmitted to the user in providing electronic commerce services.

The memory 903F also stores information associated with the electronic commerce service, or services, provided by the central station 903. This includes information for presentation to a user. The presentation can via the telephone 901 (voice), via the monitor 902C (visual), or via both the telephone 901 and the monitor 902C. This information can be stored such that it is configurable for presentation via either the telephone 901 or the monitor 902C. The information can also be stored pre-configured for presentation via the telephone 901, and can also be stored pre-configured for presentation via the monitor 902C.

The ARS database 903C, similar to the discussion above, stores rules that define default and preferred output forms for various classes and sub-classes of information exchange. These rules dictate across which session information will be presented.

As above, the rules stored in the ARS database 903C include default rules and user-specific preference rules. And also, the rules stored in the ARS database 903C include sponsor-specific rules.

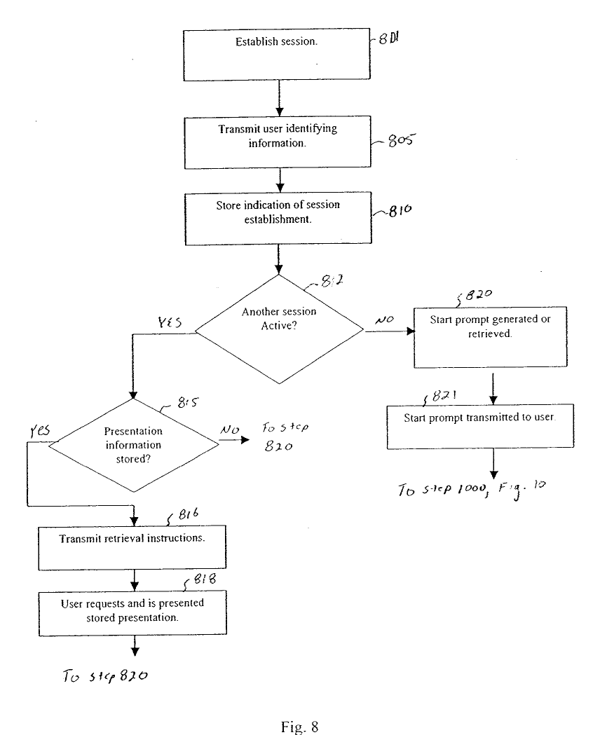

FIGS. 8 depicts exemplary operations in accessing the central station 903 to direct performance of electronic banking services via a network in accordance with this second embodiment of the present invention. Of course, as will be understood from the discussion above, other types of on-line application delivery can be facilitated by this second embodiment.

In accordance with this second embodiment, a user establishes two user sessions, one via telephone 901, and the other via customer device 902. The rules define across which of the sessions information will be transmitted to the user. At step 1001 a user establishes a session via either network.

It should be noted that two sessions do not have to be established for the central station 903 to provide and/or facilitate electronic commerce services. Furthermore, in addition to the common functionality of telephone-based and customer device-based sessions, either or both of the telephone-based session and the customer device-based session could offer functionality different than the other session.

To establish a session via network 904, a user dials a dedicated phone number associated with the central station 903. To establish a session via network 905, the user directs the client processor 902D to establish a communication link with a network address associated with the central station 903. After establishing a session, step 801, the user identifies himself or herself to the central station 903, step 805. For the session via network 905, the user provides a user name and password, as described above. For the session via network 904, the user provides a user identifier and password. This can either be via voice, with the voice recognition subsystem 903D2 transforming the voice signal to code and passing the code to the second application functionality subsystem 903E, or by touchtone, with the touchtone recognition subsystem 903D1 transforming touchtone sounds to code and passing the code to the second application functionality subsystem 903E.

Upon the establishment of a session, the application functionality subsystem with which the session has been established stores an indication in the ARS database 903C that a session has been established, and information indicating the network over which the session has been established, step 810.

The client processor 902D can optionally be configured to automatically, upon establishment of a session, transmit one or both of the user name and/or password to the central station 903.

The application functionality subsystem with which the session has been established determines if another session is active via the other network, step 812. Thus, upon establishment of a telephone-based session, the second application functionality subsystem 903E accesses the ARS database 903C to determine if a first session via network 905 is active. Also, upon establishment of a customer device-based session, the first application functionality subsystem 903B accesses the ARS database 903C to determine if a first session via network 904 is active. These determinations are made each time user input of any kind is received and information is to be presented in response to the received input.

If at step 812 it is determined that a first session is active, the application functionality subsystem with which the second session is established determines if any presentation information is stored in memory 903F for presentment via the second session, step 815. Stored presentation information will be further discussed below. If so, at step 816, the user is instructed, via a retrieval prompt, how to retrieve the stored presentation information. If this is a telephone 901 session, the aural retrieval prompt can include directing the customer to speak retrieval instructions, or to press certain keys to generate predetermined touchstones. These instructions direct the second application functionality subsystem 903E to retrieve and transmit the stored information. If this is a customer device 902 based session, the visual retrieval prompt will include a “retrieve” button which the user manually activates to cause the first application functionality subsystem 903B to retrieve and transmit the stored presentation information. At step 818 the user requests and is presented the stored presentation information. Subsequent to presentation of the stored information, operations continue with step 820.

If at step 815 it is determined that there is no stored presentation information available, operations continue with step 820.

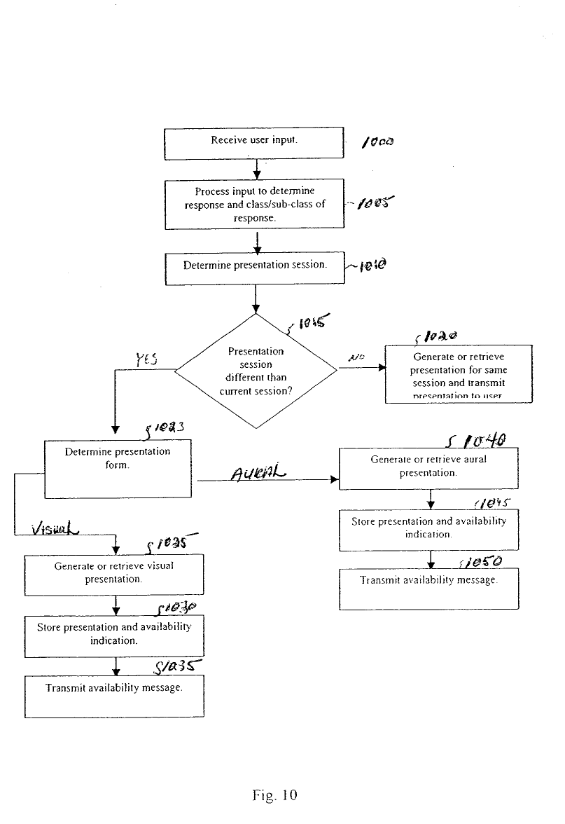

If at step 812 it is determined that no other session is active, a start prompt message is generated or retrieved and transmitted, step 820. This start prompt message conveys the same information discussed above in relation to the first embodiment. If this session is established via network 904, the start prompt is an aural start prompt for presentation via telephone 901. If this session is established via network 905, the start prompt is a visual prompt for presentation via monitor 902C. At step 821, the start prompt information is transmitted to the user. Operations continue as described below and shown in FIG. 10.

FIG. 10 depicts the processing performed in receiving information from a user. At step 1000 the user input is received. For example, this input could be a user selection in response to a start prompt, or it could be a user request for bill detail information after having been presented bill summary information. The application functionality subsystem receiving the user input processes the input to determine the appropriate response, including determining the class and/or sub-class to which the response belongs, step 1005. This application functionality subsystem then accesses the ARS database 903C and determines the session over which this class or sub-class of information is to be presented, step 1010. This could be based upon default rules, or upon sponsor or user preferences.

At step 1015 the application functionality subsystem processing the user input determines if the indicted presentment session is different than the session in which the user input was received.

If the relevant rule dictates that the class or sub-class of information is to be presented via the same session via which the input was received, operations continue with step 1020. In this step the application functionality subsystem receiving the input generates or retrieves from memory 903F the presentation, as needed, and transmits the information to the user via the same session via which the input was received. This information is then presented to the user in the appropriate form (aural or visual).

At step 1023 the application functionality subsystem processing the received user input determines if the presentation session is an aural session or a visual session, based upon the stored rules. If the relevant rule dictates that the class or sub-class of information is to be presented via visual presentation, operations continue with step 1025. If the relevant rule dictates that the class or sub-class of information is to be presented via aural presentation, operations continue with step 1040.

In step 1025 the application functionality subsystem processing the user input generates or retrieves from memory 903F the presentation, as needed. This generated or retrieved information is processed to be presented, in the present example, via monitor 902C. This processed information is then stored in memory 903F along with an indication that the information is available for presentment, step 1030. Then, at step 1035, the receiving application functionality subsystem transmits, via network 904, a message for aural presentation informing the user that the information is available for presentment via a different network session.

The user then either establishes a session via the different network and receives the stored information, as described above and depicted in step 801 through 818 of FIG. 8, or activates a “retrieve” button presented in an already active session, to cause the information to be transmitted to the customer device 902. Each instance of visual presentation, according to this embodiment, includes a “retrieve” button which causes the first application functionality subsystem 903B to retrieve any presentment information stored in memory 903F that is directed to a particular user. Therefore, a user is always able to access stored presentment information.

In step 1040 the application functionality subsystem processing the user input generates or retrieves from memory 903F the presentation to be aurally presented, as needed. This generated or retrieved information is processed to be presented, in the present example, via telephone 901. This processed information is then stored in memory 903F along with an indication that the information is available for presentment, step 1045.

The application functionality subsystem processing the user input then, at step 1050, transmits, via network 905, a message for visual presentation informing the user that the information is available for presentment via a different network session. This could include information instructing the user to speak certain commands or to cause the telephone 901 to transmit certain touchstones.

As above, the user then either establishes a session via the different network, and receives the stored information, as described above and depicted in step 801 through 818 of FIG. 8, or issues instructions (verbally or via touchtone) to retrieve the stored information if a session is already active.

Though not depicted in FIG. 9, the first and the second application functionality subsystems can be communicatively interconnected. In such a case, when the first application functionality subsystem 903B processes information for aural presentation, the first application functionality subsystem 903B, in addition to storing the presentation, transmits the presentation to the second application functionality subsystem 903E. The second application functionality subsystem 903E then causes the presentation information to be transmitted to the telephone 901 without a user request. Likewise, when the second application functionality subsystem 903E processes information for visual presentation, it transmits the presentation to the first application functionality subsystem 903B. The first application functionality subsystem 903B then causes the presentation information to be transmitted to the customer device. Alternatively, each application functionality subsystem can be configured to monitor the memory for stored presentation information. Upon detecting stored presentation information to be transmitted by an application functionality subsystem, that subsystem retrieves and transmits the information.

It should be understood that while FIG. 10 depicts each instance of presentation of information in only one form (aural or visual), each instance of presentation information can readily be presented both aurally and visually in accordance with this second embodiment, as well as in accordance with the first embodiment.

As in the first embodiment, either of the application functionality subsystems of the second embodiment can advantageously be configured to determine, for each instance of presentation of a class or sub-class of information, a preferred form of presentation (visual or aural). Thus, depending upon, for example, the volume or complexity of the information to be presented, a determination as to the most appropriate form of presentation can be made.

While the examples included above recite providing and/or facilitating financial services, a central station in accordance with either embodiment included herein can readily perform and/or facilitate other electronic commerce services. For example, presentation of a catalog of products offered for purchase can be presented visually, while pricing information is presented aurally. Still further, input of user selections can be by voice, while payment instructions is by manual input. As another example, the highly visual content of electronic greeting cards can be presented visually, while the content of the cards can be presented aurally. And still further, instructions for delivery of an electronic greeting card can be input by voice.

The present invention is not to be limited in scope by the specific embodiments described herein. Indeed, various modifications of the present invention in addition to those described herein, will be apparent to those of skill in the art from the foregoing description and accompanying drawings. Thus, such modifications are intended to fall within the scope of the appended claims.

What is claimed is:

1. A method for information exchange, comprising:
receiving a message having an input mode;
determining an output mode for a response to the received message;
generating the response to have the determined output mode; and
transmitting the generated response;
wherein the determination of the output mode is independent of the input mode.

2. The method of claim 1, wherein:
the message is received via a first network session; and
the response is transmitted via a second network session different than the first network session.

3. The method of claim 2, further comprising:
storing the generated response; and
receiving a request to receive the stored response;
wherein the response is transmitted subsequent to receipt of the request; and
wherein the request is received via one of the first or the second network sessions.

4. The method of claim 1, wherein:
the message is received via a network session; and
the response is transmitted via the same network session.

5. The method of claim 1, wherein:
the message is received from a customer of a financial services provider by the financial services provider; and
the received message is a request for the financial services provider to provide a financial service for the customer.

6. The method of claim 1, wherein the determination of the output mode is based upon at least one of 1) content of the response, 2) volume of the response, 3) preferences associated with an entity from whom the message is received, 4) preferences associated with an entity receiving the message, 5) preferences associated with a sponsor of the entity from whom the message is received, and 6) a type of device from which the message is received.

7. The method of claim 1, wherein the output mode is a first output mode, further comprising:
generating the response to have a second output mode different than the first output mode; and
transmitting the response having the second output mode;
wherein the second output mode is dependent upon the input mode;
wherein the response generated to have the first output mode conveys information; and
wherein the response generated to have the second output mode conveys at least a portion of the information.

8. The method of claim 1, wherein:
the input mode is one of a vocal input mode and a manual input mode;
the output mode is one of an aural output mode and a visual output mode.

9. The method of claim 8, further comprising:
receiving the transmitted response;
determining the output mode of the received response; and
presenting the received response;
wherein the response is presented visually if the response is determined to have the visual output mode;
wherein the response is presented aurally if the response is determined to have the aural output mode.

10. The method of claim 1, further comprising:
determining the input mode of the received message.

11. A system for information exchange, comprising:
a first network station configured to transmit a message having an input mode; and
a second network station configured to 1) receive the transmitted message, 2) determine an output mode for a response to the received message, 3) generate the response to have the determined output mode, and 4) transmit the generated response;
wherein the determination of the output mode is independent of the input mode.

12. The system of claim 11, wherein:
the message is received via a first network session; and
the response is transmitted via a second network session different than the first network session.

13. The system of claim 12, wherein:
the second network station is further configured to store the generated response and transmit the stored response subsequent to receipt of a request to receive the stored response; and
the request is transmitted via one of the first or the second network sessions.

14. The system of claim 12, further comprising:
a third network station configured to receive the transmitted response;
wherein the first network station and the second network station communicate via the first network session;
wherein the second network station and the third network station communicate via the second network session; and
wherein the response is transmitted via the second network session.

15. The system of claim 11, wherein:
the first network station is associated with a customer of a financial services provider;
the second network station is associated with the financial services provider; and
the received message is a request for the financial services provider to provide a financial service for the customer.

16. The system of claim 11, wherein the determination of the output mode is based upon at least one of 1) content of the response, 2) volume of the response, 3) preferences associated with an entity associated with the first network station, 4) preferences associated with an entity associated with the second network station, 5) preferences associated with a sponsor of the entity associated with the first network station, and 6) a type of the first network station.

17. The system of claim 11, wherein:
the output mode is first output mode;
the second network station is further configured to generate the response to have a second output mode different than the first output mode and to transmit the response having the second output mode;
the second output mode is dependent upon the input mode
the response generated to have the first output mode conveys information; and
the response generated to have the second output conveys at least a portion of the information.

18. The system of claim 11, wherein:
the input mode is one of a voice input mode and a manual input mode.
the output mode is one of an aural output mode and a visual output mode.

19. The system of claim 18, wherein:
the first network station is further configured to receive the transmitted response, determine the output mode of the received response, present the response visually if the determined output mode is the visual output mode, and present the response aurally if the determined output mode is the aural output mode.

20. The system of claim 11, wherein:
the second session station is further configured to determine the input mode of the received message.
